(19) United States
(12) Patent Application Publication
(10) Pub. No.: US 2019/0028247 A1
(43) Pub. Date: Jan. 24, 2019

(54) CHANNEL TRANSMISSION METHOD, APPARATUS, AND SYSTEM FOR NB-IOT

(71) Applicant: Huawei Technologies Co., Ltd., Shenzhen (CN)

(72) Inventors: Zheng Liu, Shenzhen (CN); Chao Luo, Shenzhen (CN); Yubo Yang, Shanghai (CN)

(21) Appl. No.: 16/137,100

(22) Filed: Sep. 20, 2018

Related U.S. Application Data
(63) Continuation of application No. PCT/CN2017/076984, filed on Mar. 16, 2017.

(30) Foreign Application Priority Data
Mar. 21, 2016 (CN) 201610162224.1

(51) Int. Cl. H04L 5/00; H04W 72/04; H04W 4/80

(52) U.S. Cl. CPC H04L 5/0012; H04W 4/80; H04W 72/0453

(57) ABSTRACT

This application provides a channel transmission method, apparatus, and system for NB-IoT. An NB-IoT base station determines, based on the frequency hopping information, a time-frequency resource location of the channel after frequency hopping, and performs channel transmission with an NB-IoT terminal on a time-frequency resource corresponding to the time-frequency resource location, so that the frequency hopping is introduced into the NB-IoT, thereby increasing a gain of frequency diversity through the frequency hopping.

### CROSS-REFERENCE TO RELATED APPLICATIONS

This application is a continuation of International Application No. PCT/CN2017/076984 filed on Mar. 16, 2017, which claims priority to Chinese Patent Application No. 201610162224.1 filed on Mar. 21, 2016, both of which are hereby incorporated by reference in their entireties.

### TECHNICAL FIELD

Embodiments of this application relate to communications technologies, and in particular, to a channel transmission method, apparatus, and system for Narrowband Internet of Things (NB-IoT).

### BACKGROUND

Internet of Things (IoT) is “the Internet connecting things to each other”. The Internet of Things expands communication between user ends in the Internet to communication between any things.

In the prior art, the 3rd generation partnership project (GPP) has passed a new research subject to study a method that supports the IoT with extremely low complexity and low costs in a cellular network, and approves the new research subject as an NB-IoT subject. The NB-IoT is a narrowband solution that is run at a 180 kHz spectrum. An NB-IoT terminal needs to perform sending and receiving only in a 180 kHz narrowband.

However, there is a problem in the prior art that a transmission bandwidth of the NB-IoT is very narrow, consequently causing a gain of frequency diversity to be relatively small.

### SUMMARY

This application provides a channel transmission method, apparatus, and system for NB-IoT, to resolve a prior-art problem that a transmission bandwidth of the NB-IoT is very narrow, consequently causing a gain of frequency diversity to be relatively small.

According to a first aspect, this application provides a channel transmission method for NB-IoT. The method includes: determining, by an NB-IoT base station, frequency hopping information of a channel; determining, based on the frequency hopping information, a time-frequency resource location of the channel after frequency hopping; and performing channel transmission with an NB-IoT terminal on a time-frequency resource corresponding to the determined time-frequency resource location.

According to the channel transmission method for NB-IoT provided in the first aspect, the NB-IoT base station determines, based on the frequency hopping information, the time-frequency resource location of the channel after the frequency hopping, and performs channel transmission with the NB-IoT terminal on the time-frequency resource corresponding to the time-frequency resource location, so that the frequency hopping is introduced into the NB-IoT, thereby increasing the gain of the frequency diversity through the frequency hopping.

In a possible design, the determining, by an NB-IoT base station, frequency hopping information of a channel includes: determining, by the NB-IoT base station, an initial frequency domain location, a frequency hopping frequency interval, and a frequency hopping time interval of the channel.

According to the channel transmission method for NB-IoT provided in the implementation, the NB-IoT base station determines the initial frequency domain location, the frequency hopping frequency interval, and the frequency hopping time interval of the channel, so that the NB-IoT base station can obtain the frequency hopping information, and then the NB-IoT base station can perform frequency hopping based on the frequency hopping information.

In a possible design, the determining, by the NB-IoT base station, an initial frequency domain location of the channel includes: determining, by the NB-IoT base station, the initial frequency domain location of the channel based on a cell identifier ID of a cell in which the channel is located; or randomly selecting, by the NB-IoT base station, the initial frequency domain location of the channel from all unallocated frequency domain locations.

In a possible design, the determining, by the NB-IoT base station, a frequency hopping time interval of the channel includes: determining, by the NB-IoT base station, the frequency hopping time interval based on a type of the channel; or determining, by the NB-IoT base station, the frequency hopping time interval based on a coverage level of the NB-IoT terminal; or selecting, by the NB-IoT base station, an interval from an interval set as the frequency hopping time interval.

In a possible design, the determining, by the NB-IoT base station, a frequency hopping frequency interval of the channel includes: determining, by the NB-IoT base station, the frequency hopping frequency interval based on a system bandwidth of the NB-IoT; or selecting, by the NB-IoT base station, a frequency from a frequency set as the frequency hopping frequency interval.

In a possible design, the time-frequency resource includes N physical resource block (PRB) groups, and each PRB group includes M consecutive PRBs, where M and N are integers greater than 0; and the frequency hopping time interval includes an intra-group frequency hopping time interval and an inter-group frequency hopping time interval; and the frequency hopping frequency interval includes an intra-group frequency hopping frequency interval and an inter-group frequency hopping frequency interval, where the intra-group frequency hopping time interval is less than the inter-group frequency hopping time interval, and a remainder of the inter-group frequency hopping time interval mod the intra-group frequency hopping time interval is non-zero; the intra-group frequency hopping frequency interval is L×W, and the inter-group frequency hopping frequency interval is O×M×W; and L and O are integers greater than 0, and W indicates a bandwidth occupied by one PRB.

According to the channel transmission method for NB-IoT provided in the implementation, PRBs are divided into groups, and a two-level frequency hopping manner of intra-group frequency hopping and inter-group frequency hopping is implemented, so that frequency hopping within a larger frequency range and a limited transmission time can be implemented. In addition, a size of a group in an NB-IoT system is set to a size of a group in an eMTC system, so that coexistence of the NB-IoT system and the eMTC system can be better implemented.

In a possible design, the determining, by the NB-IoT base station based on the initial frequency domain location, the frequency hopping frequency interval, and the frequency hopping time interval of the channel, a time-frequency resource location of the channel after frequency hopping includes: determining, by the NB-IoT base station based on the initial frequency domain location, an intra-group frequency hopping frequency domain interval, and an inter-group frequency hopping frequency domain interval of the channel, a frequency domain location of the channel after the frequency hopping; and determining, based on the intra-group frequency hopping time interval and the inter-group frequency hopping time interval of the channel, a time domain location of the channel after the frequency hopping.

In a possible design, the determining, by the NB-IoT base station based on the initial frequency domain location, an intra-group frequency hopping frequency domain interval, and an inter-group frequency hopping frequency domain interval of the channel, a frequency domain location of the channel after the frequency hopping includes:

for a frequency domain location Fᵢ of an i^{th} hop, determining a PRB group Zᵢ to which Fᵢ belongs by using the following formula (1):

Zᵢ=(Z₀+A)mod N (1); and

for the frequency domain location Fᵢ of the i^{th} hop, determining a location Pᵢ of Fᵢ in the PRB group by using the following formula (2):

Pᵢ=(P₀+B) mod M (2)

where i is an integer greater than 0, Z₀ indicates a PRB group to which an initial frequency domain location F₀ belongs, P₀ indicates a location of F₀ in the PRB group, A indicates the inter-group frequency hopping frequency domain interval, and B indicates the intra-group frequency hopping frequency domain interval.

In a possible design, the determining, by the NB-IoT base station based on the intra-group frequency hopping time interval and the inter-group frequency hopping time interval of the channel, a time domain location of the channel after the frequency hopping includes:

for a time domain location Tᵢ₊₁ of an (i+1)^{th} hop, when i+1 is an integer multiple of C mod D, determining Tᵢ₊₁ by using the following formula (3); otherwise, determining Tᵢ₊₁ by using the following formula (4):

Tᵢ₊₁=Tᵢ+(C mod D) (3)

Tᵢ₊₁=Tᵢ+D (4)

where i is an integer greater than 0, Tᵢ indicates a time domain location of an i^{th} hop, C indicates the inter-group frequency hopping time interval, and D indicates the intra-group frequency hopping time interval.

In a possible design, a deployment manner of the NB-IoT includes: inband deployment, guard band deployment, or independent frequency band deployment.

In a possible design, a deployment manner of the NB-IoT is guard band deployment, a frequency domain location of an i^{th} hop of the channel is located within a guard band of one end of an LTE system transmission band, and a frequency domain location of an (i+1)^{th} hop of the channel is located within a guard band of the other end of the LTE system transmission band, where i is an integer greater than 0.

According to the channel transmission method for NB-IoT provided in the implementation, the frequency domain location of the i^{th} hop of the channel is located within the guard band of one end of the LTE system transmission band, and the frequency domain location of the (i+1)^{th} hop of the channel is located within the guard band of the other end of the LTE system transmission band, so that the channel can obtain a relatively large gain of the frequency diversity.

According to a second aspect, an embodiment of this application provides a channel transmission method for NB-IoT. The method includes: determining, by an NB-IoT terminal, frequency hopping information of a channel; determining, based on the frequency hopping information, a time-frequency resource location of the channel after frequency hopping; and performing channel transmission with an NB-IoT base station on a time-frequency resource corresponding to the determined time-frequency resource location.

In a possible design, the determining, by an NB-IoT terminal, frequency hopping information of a channel includes: determining, by the NB-IoT terminal, an initial frequency domain location, a frequency hopping frequency interval, and a frequency hopping time interval of the channel.

In a possible design, the determining, by the NB-IoT terminal, an initial frequency domain location of the channel includes: determining, by the NB-IoT terminal, the initial frequency domain location of the channel based on a cell identifier ID of a cell in which the channel is located; or determining, by the NB-IoT terminal, the initial frequency domain location based on first notification signaling that is sent by the NB-IoT base station and that is used for indicating the initial frequency domain location.

In a possible design, the determining, by the NB-IoT terminal, a frequency hopping time interval of the channel includes: determining, by the NB-IoT terminal, the frequency hopping time interval based on a type of the channel; or determining, by the NB-IoT terminal, the frequency hopping time interval based on a coverage level of the NB-IoT terminal; or determining, by the NB-IoT terminal, the frequency hopping time interval based on second notification signaling that is sent by the NB-IoT base station and that is used for indicating the frequency hopping time interval.

In a possible design, the determining, by the NB-IoT terminal, a frequency hopping frequency interval of the channel includes: determining, by the NB-IoT terminal, the frequency hopping frequency interval based on a system bandwidth of the NB-IoT; or determining, by the NB-IoT terminal, the frequency hopping frequency interval based on third notification signaling that is sent by the NB-IoT base station and that is used for indicating the frequency hopping frequency interval.

In a possible design, the time-frequency resource includes N physical resource block PRB groups, and each PRB group includes M consecutive PRBs, where M and N are integers greater than 0; and the frequency hopping time interval includes an intra-group frequency hopping time interval and an inter-group frequency hopping time interval; and the frequency hopping frequency interval includes an intra-group frequency hopping frequency interval and an inter-group frequency hopping frequency interval, where the intra-group frequency hopping time interval is less than the inter-group frequency hopping time interval, and a remainder of the inter-group frequency hopping time interval mod the intra-group frequency hopping time interval is non-zero; the intra-group frequency hopping frequency interval is L×W, and the inter-group frequency hopping frequency interval is O×M×W; and L and O are integers greater than 0, and W indicates a bandwidth occupied by one PRB.

In a possible design, the determining, by the NB-IoT terminal based on the initial frequency domain location, the frequency hopping frequency interval, and the frequency hopping time interval of the channel, a time-frequency resource location of the channel after frequency hopping includes: determining, by the NB-IoT terminal based on the initial frequency domain location, an intra-group frequency hopping frequency domain interval, and an inter-group frequency hopping frequency domain interval of the channel, a frequency domain location of the channel after the frequency hopping; and determining, by the NB-IoT terminal based on the intra-group frequency hopping time interval and the inter-group frequency hopping time interval of the channel, a time domain location of the channel after the frequency hopping.

In a possible design, the determining, by the NB-IoT terminal based on the initial frequency domain location, an intra-group frequency hopping frequency domain interval, and an inter-group frequency hopping frequency domain interval of the channel, a frequency domain location of the channel after the frequency hopping includes:

for a frequency domain location Fᵢ of an i^{th} hop, determining a PRB group Zᵢ to which Fᵢ belongs by using the following formula (1):

Zᵢ=(Z₀+A)mod N (1); and

for the frequency domain location Fᵢ of the i^{th} hop, determining a location Pᵢ of Fᵢ in the PRB group by using the following formula (2):

Pᵢ=(P₀+B) mod M (2)

where i is an integer greater than 0, Z₀ indicates a PRB group to which an initial frequency domain location F₀ belongs, P₀ indicates a location of F₀ in the PRB group, A indicates the inter-group frequency hopping frequency domain interval, and B indicates the intra-group frequency hopping frequency domain interval.

In a possible design, the determining, by the NB-IoT terminal based on the intra-group frequency hopping time interval and the inter-group frequency hopping time interval of the channel, a time domain location of the channel after the frequency hopping includes:

for a time domain location Tᵢ₊₁ of an (i+1)^{th} hop, when i+1 is an integer multiple of C mod D, determining Tᵢ₊₁ by using the following formula (3); otherwise, determining Tᵢ₊₁ by using the following formula (4):

Tᵢ₊₁=Tᵢ+(C mod D) (3)

Tᵢ₊₁=Tᵢ+D (4)

where i is an integer greater than 0, Tᵢ indicates a time domain location of an i^{th} hop, C indicates the inter-group frequency hopping time interval, and D indicates the intra-group frequency hopping time interval.

In a possible design, a deployment manner of the NB-IoT includes: inband deployment, guard band deployment, or independent frequency band deployment.

In a possible design, a deployment manner of the NB-IoT is guard band deployment, a frequency domain location of an i^{th} hop of the channel is located within a guard band of one end of an LTE system transmission band, and a frequency domain location of an (i+1)^{th} hop of the channel is located within a guard band of the other end of the LTE system transmission band, where i is an integer greater than 0.

For beneficial effects of the channel transmission method for NB-IoT provided in the second aspect and the possible implementations of the second aspect, refer to beneficial effects brought by the first aspect and the possible implementations of the first aspect. Details are not described herein again.

According to a third aspect, an embodiment of this application provides a channel transmission apparatus for NB-IoT, including: a frequency hopping information determining module, a time-frequency resource location determining module, and a transmission module. The frequency hopping information determining module determines frequency hopping information of a channel; the time-frequency resource location determining module determines, based on the frequency hopping information, a time-frequency resource location of the channel after frequency hopping; and the transmission module performs channel transmission with an NB-IoT terminal on a time-frequency resource corresponding to the time-frequency resource location.

In a possible design, the frequency hopping information determining module is configured to determine an initial frequency domain location, a frequency hopping frequency interval, and a frequency hopping time interval of the channel.

In a possible design, that the frequency hopping information determining module determines an initial frequency domain location of the channel includes: determining the initial frequency domain location of the channel based on a cell identifier ID of a cell in which the channel is located; or randomly selecting the initial frequency domain location of the channel from all unallocated frequency domain locations.

In a possible design, that the frequency hopping information determining module determines a frequency hopping time interval of the channel includes: determining the frequency hopping time interval based on a type of the channel; or determining the frequency hopping time interval based on a coverage level of the NB-IoT terminal; or selecting an interval from an interval set as the frequency hopping time interval.

In a possible design, that the frequency hopping information determining module determines a frequency hopping frequency interval of the channel includes: determining the frequency hopping frequency interval based on a system bandwidth of the NB-IoT; or selecting a frequency from a frequency set as the frequency hopping frequency interval.

In a possible design, the time-frequency resource includes N physical resource block PRB groups, and each PRB group includes M consecutive PRBs, where M and N are integers greater than 0; and the frequency hopping time interval includes an intra-group frequency hopping time interval and an inter-group frequency hopping time interval; and the frequency hopping frequency interval includes an intra-group frequency hopping frequency interval and an inter-group frequency hopping frequency interval, where the intra-group frequency hopping time interval is less than the inter-group frequency hopping time interval, and a remainder of the inter-group frequency hopping time interval mod the intra-group frequency hopping time interval is non-zero; the intra-group frequency hopping frequency interval is L×W, and the inter-group frequency hopping frequency interval is O×M×W; and L and O are integers greater than 0, and W indicates a bandwidth occupied by one PRB.

In a possible design, the time-frequency resource location determining module is configured to: determine, based on the initial frequency domain location, the intra-group frequency hopping frequency domain interval, and the inter-group frequency hopping frequency domain interval of the channel, a frequency domain location of the channel after the frequency hopping; and determine, based on the intra-group frequency hopping time interval and the inter-group frequency hopping time interval of the channel, a time domain location of the channel after the frequency hopping.

In a possible design, that the time-frequency resource location determining module determines, based on the initial frequency domain location, an intra-group frequency hopping frequency domain interval, and an inter-group frequency hopping frequency domain interval of the channel, a frequency domain location of the channel after the frequency hopping includes:

for a frequency domain location Fᵢ of an i^{th} hop, determining a PRB group Zᵢ to which Fᵢ belongs by using the following formula (1):

Zᵢ=(Z₀+A)mod N (1); and

for the frequency domain location Fᵢ of the i^{th} hop, determining a location Pᵢ of Fᵢ in the PRB group by using the following formula (2):

Pᵢ=(P₀+B) mod M (2)

where i is an integer greater than 0, Z₀ indicates a PRB group to which an initial frequency domain location F₀ belongs, P₀ indicates a location of F₀ in the PRB group, A indicates the inter-group frequency hopping frequency domain interval, and B indicates the intra-group frequency hopping frequency domain interval.

In a possible design, that the time-frequency resource location determining module determines, based on the intra-group frequency hopping time interval and the inter-group frequency hopping time interval of the channel, a time domain location of the channel after the frequency hopping includes:

for a time domain location Tᵢ₊₁ of an (i+1)^{th} hop, when i+1 is an integer multiple of C mod D, determining Tᵢ₊₁ by using the following formula (3); otherwise, determining Tᵢ₊₁ by using the following formula (4):

Tᵢ₊₁=Tᵢ+(C mod D) (3)

Tᵢ₊₁=Tᵢ+D (4)

where i is an integer greater than 0, Tᵢ indicates a time domain location of an i^{th} hop, C indicates the inter-group frequency hopping time interval, and D indicates the intra-group frequency hopping time interval.

In a possible design, a deployment manner of the NB-IoT includes: inband deployment, guard band deployment, or independent frequency band deployment.

In a possible design, a deployment manner of the NB-IoT is guard band deployment, a frequency domain location of an i^{th} hop of the channel is located within a guard band of one end of an LTE system transmission band, and a frequency domain location of an (i+1)^{th} hop of the channel is located within a guard band of the other end of the LTE system transmission band, where i is an integer greater than 0.

For beneficial effects of the channel transmission apparatus for NB-IoT provided in the third aspect and the possible implementations of the third aspect, refer to beneficial effects brought by the first aspect and the possible implementations of the first aspect. Details are not described herein again.

According to a fourth aspect, an embodiment of this application provides a channel transmission apparatus for NB-IoT, including: a frequency hopping information determining module, a time-frequency resource location determining module, and a transmission module. The frequency hopping information determining module determines frequency hopping information of a channel; the time-frequency resource location determining module determines, based on the frequency hopping information, a time-frequency resource location of the channel after frequency hopping; and the transmission module performs channel transmission with an NB-IoT base station on a time-frequency resource corresponding to the time-frequency resource location.

In a possible design, the frequency hopping information determining module is configured to determine an initial frequency domain location, a frequency hopping frequency interval, and a frequency hopping time interval of the channel.

In a possible design, that the frequency hopping information determining module determines an initial frequency domain location of the channel includes: determining the initial frequency domain location of the channel based on a cell identifier ID of a cell in which the channel is located; or determining the initial frequency domain location based on first notification signaling that is sent by the NB-IoT base station and that is used for indicating the initial frequency domain location.

In a possible design, that the frequency hopping information determining module determines a frequency hopping time interval of the channel includes: determining the frequency hopping time interval based on a type of the channel; or determining the frequency hopping time interval based on a coverage level at which an NB-IoT terminal is located; or determining the frequency hopping time interval based on second notification signaling that is sent by the NB-IoT base station and that is used for indicating the frequency hopping time interval.

In a possible design, that the frequency hopping information determining module determines a frequency hopping frequency interval of the channel includes: determining the frequency hopping frequency interval based on a system bandwidth of the NB-IoT; or determining the frequency hopping frequency interval based on third notification signaling that is sent by the NB-IoT base station and that is used for indicating the frequency hopping frequency interval.

In a possible design, the time-frequency resource includes N physical resource block PRB groups, and each PRB group includes M consecutive PRBs, where M and N are integers greater than 0; and the frequency hopping time interval includes an intra-group frequency hopping time interval and an inter-group frequency hopping time interval; and the frequency hopping frequency interval includes an intra-group frequency hopping frequency interval and an inter-group frequency hopping frequency interval, where the intra-group frequency hopping time interval is less than the inter-group frequency hopping time interval, and a remainder of the inter-group frequency hopping time interval mod the intra-group frequency hopping time interval is non-zero; the intra-group frequency hopping frequency interval is L×W, and the inter-group frequency hopping frequency interval is O×M×W; and L and O are integers greater than 0, and W indicates a bandwidth occupied by one PRB.

In a possible design, the time-frequency resource location determining module is configured to: determine, based on the initial frequency domain location, an intra-group frequency hopping frequency domain interval, and an inter-group frequency hopping frequency domain interval of the channel, a frequency domain location of the channel after the frequency hopping; and determine, based on the intra-group frequency hopping time interval and the inter-group frequency hopping time interval of the channel, a time domain location of the channel after the frequency hopping.

In a possible design, that the time-frequency resource location determining module determines, based on the initial frequency domain location, an intra-group frequency hopping frequency domain interval, and an inter-group frequency hopping frequency domain interval of the channel, a frequency domain location of the channel after the frequency hopping includes:

for a frequency domain location Fᵢ of an i^{th} hop, determining a PRB group Zᵢ to which Fᵢ belongs by using the following formula (1):

Zᵢ=(Z₀+A)mod N (1); and

for the frequency domain location Fᵢ of the i^{th} hop, determining a location Pᵢ of Fᵢ in the PRB group by using the following formula (2):

Pᵢ=(P₀+B) mod M (2)

where i is an integer greater than 0, Z₀ indicates a PRB group to which an initial frequency domain location F₀ belongs, P₀ indicates a location of F₀ in the PRB group, A indicates the inter-group frequency hopping frequency domain interval, and B indicates the intra-group frequency hopping frequency domain interval.

In a possible design, that the time-frequency resource location determining module determines, based on the intra-group frequency hopping time interval and the inter-group frequency hopping time interval of the channel, a time domain location of the channel after the frequency hopping includes:

for a time domain location Tᵢ₊₁ of an (i+1)^{th} hop, when i+1 is an integer multiple of C mod D, determining Tᵢ₊₁ by using the following formula (3); otherwise, determining Tᵢ₊₁ by using the following formula (4):

Tᵢ₊₁=Tᵢ+(C mod D) (3)

Tᵢ₊₁=Tᵢ+D (4).

where i is an integer greater than 0, Tᵢ indicates a time domain location of an i^{th} hop, C indicates the inter-group frequency hopping time interval, and D indicates the intra-group frequency hopping time interval.

In a possible design, a deployment manner of the NB-IoT includes: inband deployment, guard band deployment, or independent frequency band deployment.

In a possible design, a deployment manner of the NB-IoT is guard band deployment, a frequency domain location of an i^{th} hop of the channel is located within a guard band of one end of an LTE system transmission band, and a frequency domain location of an (i+1)^{th} hop of the channel is located within a guard band of the other end of the LTE system transmission band, where i is an integer greater than 0.

For beneficial effects of the channel transmission apparatus for NB-IoT provided in the fourth aspect and the possible implementations of the fourth aspect, refer to beneficial effects brought by the first aspect and the possible implementations of the first aspect. Details are not described herein again.

According to a fifth aspect, an embodiment of this application provides a channel transmission system for NB-IoT, including: the channel transmission apparatus for NB-IoT provided in the third aspect and the possible implementations of the third aspect, and the channel transmission apparatus provided in the fourth aspect and the possible implementations of the fourth aspect.

For beneficial effects of the channel transmission system for NB-IoT provided in the fifth aspect, refer to beneficial effects brought by the first aspect and the possible implementations of the first aspect. Details are not described herein again.

### BRIEF DESCRIPTION OF THE DRAWINGS

FIG. 1 is a flowchart of Embodiment 1 of a channel transmission method for NB-IoT according to this application;

FIG. 2 is a schematic diagram of intra-group and inter-group frequency hopping of Embodiment 3 of a channel transmission method for NB-IoT according to this application;

FIG. 3 is a schematic diagram of frequency hopping of Embodiment 4 of a channel transmission method for NB-IoT according to this application;

FIG. 4 is a schematic structural diagram of Embodiment 1 of a channel transmission apparatus for NB-IoT according to this application; and

FIG. 5 is a schematic structural diagram of Embodiment 1 of an NB-IoT base station according to this application.

### DETAILED DESCRIPTION

This application is applied to NB-IoT, and the NB-IoT includes an NB-IoT terminal and an NB-IoT base station. A narrowband (NB) means that, the NB-IoT terminal needs to perform sending and receiving only in a 180 kHz narrowband. Correspondingly, the NB-IoT base station needs to communicate with the same NB-IoT terminal only in the 180 kHz narrowband.

There are the following three deployment manners of the NB-IoT:

1. Independent frequency band deployment: An independent frequency band is used in this deployment. For example, one or more carriers of a GSM network are used.

2. Guard band deployment: A resource block unused in a Long Term Evolution (LTE) guard band is used in this deployment.

3. Inband deployment: One or more physical resource blocks (PRB) on an LTE carrier are used in this deployment.

It should be noted that, a function of the NB-IoT base station in this application may be implemented by using a base station in an existing deployed cellular network. The NB-IoT terminal in this application may be a terminal that performs thing-to-thing communication in Internet of Things.

A transmission bandwidth of the NB-IoT is very narrow, and therefore there is a problem that a gain of frequency diversity is relatively small.

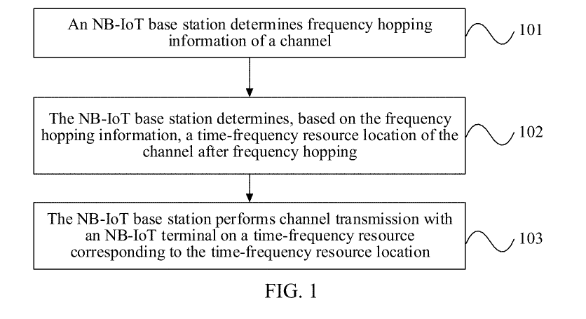

FIG. 1 is a flowchart of Embodiment 1 of a channel transmission method for NB-IoT according to this application. As shown in FIG. 1, the method in this embodiment may include the following steps.

Step 101: An NB-IoT base station determines frequency hopping information of a channel.

Step 102: The NB-IoT base station determines, based on the frequency hopping information, a time-frequency resource location of the channel after frequency hopping.

Optionally, the time-frequency resource location includes a time domain location and a frequency domain location.

Step 103: The NB-IoT base station performs channel transmission with an NB-IoT terminal on a time-frequency resource corresponding to the time-frequency resource location.

In this step, the NB-IoT base station transmits a channel to the NB-IoT terminal on the time-frequency resource corresponding to the time-frequency resource location; or the NB-IoT base station receives, on the time-frequency resource corresponding to the time-frequency resource location, a channel transmitted by the NB-IoT terminal.

In this embodiment, the NB-IoT base station determines, based on the frequency hopping information, the time-frequency resource location of the channel after frequency hopping, and performs channel transmission with the NB-IoT terminal on the time-frequency resource corresponding to the time-frequency resource location, so that the frequency hopping is introduced into the NB-IoT, thereby increasing the gain of the frequency diversity through the frequency hopping.

It should be noted that, step 101 to step 103 may alternatively be performed by the NB-IoT terminal, and this corresponds to implementation on an NB-IoT terminal side. In the implementation on the NB-IoT terminal side, it needs only to change an execution body of step 101 and step 102 from the NB-IoT base station to the NB-IoT terminal, and change step 103 to that the NB-IoT terminal performs channel transmission with the NB-IoT base station on the time-frequency resource corresponding to the time-frequency resource location.

### Embodiment 2 of a Channel Transmission Method for NB-IoT

Optionally, based on Embodiment 1 of the channel transmission method for NB-IoT in this application, step 101 may include: determining, by the NB-IoT base station, an initial frequency domain location, a frequency hopping frequency interval, and a frequency hopping time interval of the channel.

Correspondingly, for an NB-IoT terminal side, that an NB-IoT terminal determines frequency hopping information of a channel may include: determining, by the NB-IoT terminal, an initial frequency domain location, a frequency hopping frequency interval, and a frequency hopping time interval of the channel.

Optionally, the determining, by the NB-IoT base station, an initial frequency domain location of the channel may include: determining, by the NB-IoT base station, the initial frequency domain location of the channel based on a cell identifier ID of a cell in which the channel is located; or randomly selecting, by the NB-IoT base station, the initial frequency domain location of the channel from all unallocated frequency domain locations.

Optionally, the determining, by the NB-IoT base station, a frequency hopping time interval of the channel may include: determining, by the NB-IoT base station, the frequency hopping time interval based on a type of the channel; or determining, by the NB-IoT base station, the frequency hopping time interval based on a coverage level of the NB-IoT terminal; or selecting, by the NB-IoT base station, an interval from an interval set as the frequency hopping time interval.

Optionally, the determining, by the NB-IoT base station, a frequency hopping frequency interval of the channel includes: determining, by the NB-IoT base station, the frequency hopping frequency interval based on a system bandwidth of the NB-IoT; or selecting, by the NB-IoT base station, a frequency from a frequency set as the frequency hopping frequency interval.

Optionally, the determining, by the NB-IoT terminal, an initial frequency domain location of the channel includes: determining, by the NB-IoT terminal, the initial frequency domain location of the channel based on a cell identifier ID of a cell in which the channel is located; or determining, by the NB-IoT terminal, the initial frequency domain location based on first notification signaling sent by the NB-IoT base station, where the first notification signaling is used for indicating the initial frequency domain location.

Optionally, the determining, by the NB-IoT terminal, a frequency hopping time interval of the channel includes: determining, by the NB-IoT terminal, the frequency hopping time interval based on a type of the channel; or determining, by the NB-IoT terminal, the frequency hopping time interval based on a coverage level of the NB-IoT terminal; or determining, by the NB-IoT terminal, the frequency hopping time interval based on second notification signaling sent by the NB-IoT base station, where the second notification signaling is used for indicating the frequency hopping time interval.

Optionally, the determining, by the NB-IoT terminal, a frequency hopping frequency interval of the channel includes: determining, by the NB-IoT terminal, the frequency hopping frequency interval based on a system bandwidth of the NB-IoT; or determining, by the NB-IoT terminal, the frequency hopping frequency interval based on third notification signaling sent by the NB-IoT base station, where the third notification signaling is used for indicating the frequency hopping frequency interval.

It should be noted that, the first notification signaling, the second notification signaling, and the third notification signaling may be same notification signaling, or may be different notification signaling.

The following describes, by using examples, manners of determining frequency hopping information of different channels.

1. Narrowband-Physical Broadcast Channel (NB-PBCH)

An initial frequency domain location of an NB-PBCH may be determined by using a cell identifier ID of a cell in which the channel is located, a frequency hopping time interval and a frequency hopping frequency interval of the NB-PBCH may be preset values, and the preset values may be values specified by a related protocol.

It should be noted that, in an inband deployment scenario, when NB-PBCH channel transmission is performed between the NB-IoT terminal and the NB-IoT base station, the NB-IoT terminal cannot determine the system bandwidth of the NB-IoT. Therefore, NB-PBCH frequency hopping may be performed by assuming that the system bandwidth of the NB-IoT is a minimum bandwidth. For example, it is assumed that the minimum bandwidth is 3 MHz (corresponding to 15 PRBs), and because six most central PRBs of an LTE system are used for transmitting a synchronization signal or a broadcast channel of the LTE system, the NB-PBCH may perform frequency hopping within a 3 MHz bandwidth range with an NB-IoT center frequency as the center except a bandwidth range corresponding to the six most central PRBs of the LTE system. In a guard band deployment scenario, an initial frequency offset when the NB-IoT terminal performs network synchronization can indicate a system bandwidth that can be used for LTE.

2. Channel of a Narrowband-System Information Block 1 (NB-SIB1)

Before performing NB-SIB1 transmission, the NB-IoT terminal and the NB-IoT base station has obtained the system bandwidth of the NB-IoT by using master information block (MIB) information carried on the NB-PBCH. Therefore for the NB-SIB1, frequency hopping may be performed within a transmission bandwidth of the NB-IoT.

When needing to indicate an initial frequency domain location, a frequency hopping time interval, and a frequency hopping frequency interval of the NB-SIB1 by using notification signaling, the NB-IoT base station may implement the indicating by using the MIB information carried on the NB-PBCH.

3. Narrowband-Physical Downlink Control Channel (NB-PDCCH)

When needing to indicate an initial frequency domain location, a frequency hopping time interval, and a frequency hopping frequency interval of the NB-PDCCH by using notification signaling, the NB-IoT base station may implement the indicating by using NB-SIB1 information or Radio Resource Control (RRC) signaling.

4. Narrowband-Physical Downlink Shared Channel (NB-PDSCH)

When needing to indicate an initial frequency domain location, a frequency hopping time interval, and a frequency hopping frequency interval of the NB-PDSCH by using notification signaling, the NB-IoT base station may implement the indicating by using RRC signaling or by using downlink control information (DCI) signaling carried on the NB-PDCCH.

5. Narrowband-Physical Uplink Shared Channel (NB-PUSCH)

When needing to indicate an initial frequency domain location, a frequency hopping time interval, and a frequency hopping frequency interval of the NB-PUSCH by using notification signaling, the NB-IoT base station may implement the indicating by using the RRC signaling or by using the DCI signaling carried on the NB-PDCCH.

In this embodiment, the NB-IoT terminal (or the NB-IoT base station) determines the initial frequency domain location, the frequency hopping frequency interval, and the frequency hopping time interval of the channel, so that the NB-IoT terminal (or the NB-IoT base station) can obtain the frequency hopping information, and then the NB-IoT terminal (or the NB-IoT base station) can perform frequency hopping based on the frequency hopping information.

### Embodiment 3 of a Channel Transmission Method for NB-IoT

Optionally, based on Embodiment 1 or Embodiment 2 of the channel transmission method for NB-IoT in this application, the time-frequency resource includes N physical resource block PRB groups, and each PRB group includes M consecutive PRBs, where M and N are integers greater than 0; and

correspondingly, the frequency hopping time interval includes an intra-group frequency hopping time interval and an inter-group frequency hopping time interval; and the frequency hopping frequency interval includes an intra-group frequency hopping frequency interval and an inter-group frequency hopping frequency interval, where

the intra-group frequency hopping time interval is less than the inter-group frequency hopping time interval, and a remainder of the inter-group frequency hopping time interval mod the intra-group frequency hopping time interval is non-zero; the intra-group frequency hopping frequency interval is L×W, and the inter-group frequency hopping frequency interval is O×M×W; and L and O are integers greater than 0, and W indicates a bandwidth occupied by one PRB.

Optionally, the determining, by the NB-IoT base station (or the NB-IoT terminal) based on the initial frequency domain location, the frequency hopping frequency interval, and the frequency hopping time interval of the channel, a time-frequency resource location of the channel after frequency hopping includes:

determining, by the NB-IoT base station (or the NB-IoT terminal) based on the initial frequency domain location, an intra-group frequency hopping frequency domain interval, and an inter-group frequency hopping frequency domain interval of the channel, a frequency domain location of the channel after the frequency hopping; and

determining, by the NB-IoT base station (or the NB-IoT terminal) based on the intra-group frequency hopping time interval and the inter-group frequency hopping time interval of the channel, a time domain location of the channel after the frequency hopping.

Optionally, the determining, the NB-IoT base station (or the NB-IoT terminal) based on the initial frequency domain location, an intra-group frequency hopping frequency domain interval, and an inter-group frequency hopping frequency domain interval of the channel, a frequency domain location of the channel after the frequency hopping includes:

for a frequency domain location Fᵢ of an i^{th} hop, determining a PRB group Zᵢ to which Fᵢ belongs by using the following formula (1):

Zᵢ=(Z₀+A)mod N (1); and

for the frequency domain location Fᵢ of the i^{th} hop, determining a location Pᵢ of Fᵢ in the PRB group by using the following formula (2):

Pᵢ=(P₀+B) mod M (2)

where i is an integer greater than 0, Z₀ indicates a PRB group to which an initial frequency domain location F₀ belongs, P₀ indicates a location of F₀ in the PRB group, A indicates the inter-group frequency hopping frequency domain interval, and B indicates the intra-group frequency hopping frequency domain interval.

Optionally, the determining, by the NB-IoT base station (or the NB-IoT terminal) based on the intra-group frequency hopping time interval and the inter-group frequency hopping time interval of the channel, a time domain location of the channel after the frequency hopping includes:

for a time domain location Tᵢ₊₁ of an (i+1)^{th} hop, when i+1 is an integer multiple of C mod D, determining Tᵢ₊₁ by using the following formula (3); otherwise, determining Tᵢ₊₁ by using the following formula (4):

Tᵢ₊₁=Tᵢ+(C mod D) (3)

Tᵢ₊₁=Tᵢ+D (4)

where i is an integer greater than 0, Tᵢ indicates a time domain location of an i^{th} hop, C indicates the inter-group frequency hopping time interval, and D indicates the intra-group frequency hopping time interval.

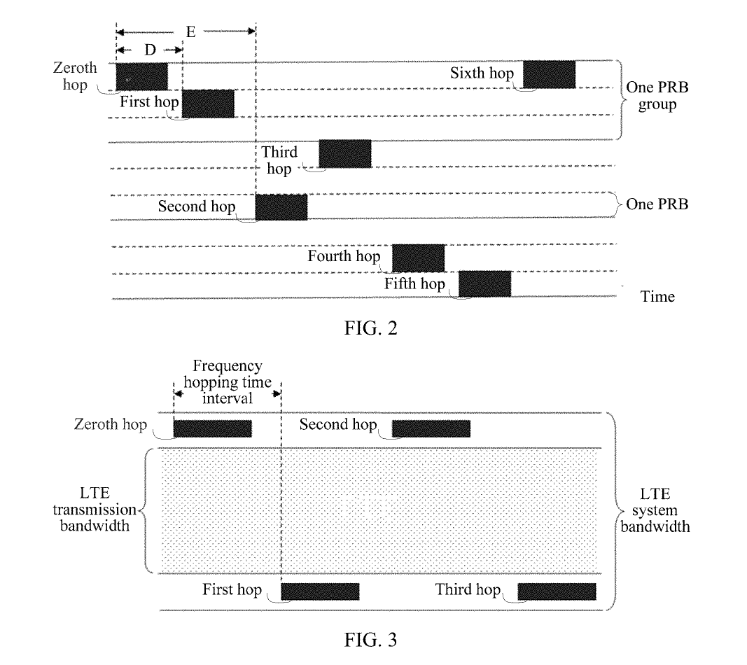

FIG. 2 is a schematic diagram of intra-group and inter-group frequency hopping of Embodiment 3 of a channel transmission method for NB-IoT according to this application. Descriptions are provided by using an example in which both M and N are 3. Black boxes indicate time domain locations and frequency domain locations of the channel after frequency hopping.

Optionally, M may be pre-agreed on by the NB-IoT base station and the NB-IoT terminal, and N may be further determined based on the system bandwidth of the NB-IoT. For example, it is assumed that one PRB group includes three consecutive PRBs, and an NB-IoT system with a 10 MHz bandwidth includes 50/3=16 PRB groups.

Alternatively, optionally, N may be determined based on the system bandwidth of the NB-IoT, and after N is determined, M is further determined based on N and the system bandwidth of the NB-IoT.

In this embodiment, PRBs are divided into groups, and a two-level frequency hopping manner of intra-group frequency hopping and inter-group frequency hopping is implemented, so that frequency hopping within a larger frequency range and a limited transmission time can be implemented. In addition, a size of a group in an NB-IoT system is set to a size of a group in an enhanced machine type communication (eMTC) system, so that coexistence of the NB-IoT system and the eMTC system can be better implemented.

### Embodiment 4 of a Channel Transmission Method for NB-IoT

Optionally, based on Embodiment 1 or Embodiment 2 of the channel transmission method for NB-IoT in this application, when a deployment manner of the NB-IoT is guard band deployment, a frequency domain location of an i^{th} hop of the channel is located within a guard band of one end of a Long Term Evolution LTE system transmission band, and a frequency domain location of an (i+1)^{th} hop of the channel is located within a guard band of the other end of the LTE system transmission band, where i is an integer greater than 0.

FIG. 3 is a schematic diagram of frequency hopping of Embodiment 4 of a channel transmission method for NB-IoT according to this application. Black boxes indicate time domain locations and frequency domain locations of the channel after frequency hopping.

In this case, that an initial frequency domain location of an NB-PBCH is determined by using a cell identifier ID of a cell in which the channel is located may be: parity of the cell ID is used to implicitly indicate that the initial frequency domain location is within which one of guard bands at two ends.

In this embodiment, the frequency domain location of the i^{th} hop of the channel is located within the guard band of one end of the Long Term Evolution LTE system transmission band, and the frequency domain location of the (i+1)^{th} hop of the channel is located within the guard band of the other end of the LTE system transmission band, so that the channel can obtain a relatively large gain of the frequency diversity.

It should be noted that, the solutions in Embodiment 1 to Embodiment 3 of the channel transmission method for NB-IoT are applied to NB-IoT whose deployment manner is inband deployment, guard band deployment, and independent frequency band deployment; the solution in Embodiment 4 of the channel transmission method for NB-IoT may be applied to NB-IoT whose deployment manner is the guard band deployment.

It should be noted that, when the deployment manner of the NB-IoT is the inband deployment, in this application, the system bandwidth of the NB-IoT may be a system bandwidth of an LTE system to which an LTE carrier used in the inband deployment belongs; when the deployment manner of the NB-IoT is the guard band deployment, in this application, the system bandwidth of the NB-IoT may be a bandwidth of a guard band; or when the deployment manner of the NB-IoT is the independent frequency band deployment, in this application, the system bandwidth of the NB-IoT may be a bandwidth of an independent frequency band occupied by the NB-IoT.

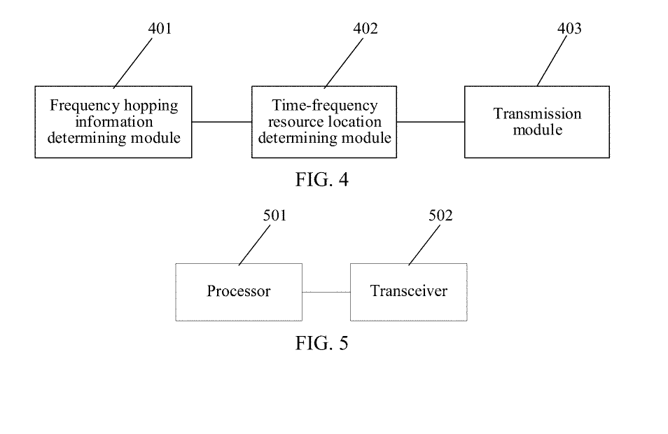

FIG. 4 is a schematic structural diagram of Embodiment 1 of a channel transmission apparatus for NB-IoT according to this application. As shown in FIG. 4, the apparatus in this embodiment may include: a frequency hopping information determining module 401, a time-frequency resource location determining module 402, and a transmission module 403. The frequency hopping information determining module 401 is configured to determine frequency hopping information of a channel; the time-frequency resource location determining module 402 is configured to determine, based on the frequency hopping information, a time-frequency resource location of the channel after frequency hopping; and the transmission module 403 is configured to perform channel transmission with an NB-IoT terminal on a time-frequency resource corresponding to the time-frequency resource location.

The apparatus in this embodiment may be configured to execute the technical solution on an NB-IoT base station side in the method embodiment shown in FIG. 1. The implementation principle and technical effects are similar. Details are not described herein again.

### Embodiment 2 of a Channel Transmission Apparatus for NB-IoT

Optionally, based on Embodiment 1 of the channel transmission apparatus for NB-IoT in this application, the frequency hopping information determining module 401 is configured to determine an initial frequency domain location, a frequency hopping frequency interval, and a frequency hopping time interval of the channel.

Optionally, that the frequency hopping information determining module 401 determines an initial frequency domain location of the channel includes:

determining the initial frequency domain location of the channel based on a cell identifier ID of a cell in which the channel is located; or randomly selecting the initial frequency domain location of the channel from all unallocated frequency domain locations.

Optionally, that the frequency hopping information determining module 401 determines a frequency hopping time interval of the channel includes:

determining the frequency hopping time interval based on a type of the channel; or determining the frequency hopping time interval based on a coverage level of the NB-IoT terminal; or selecting an interval from an interval set as the frequency hopping time interval.

Optionally, that the frequency hopping information determining module 401 determines a frequency hopping frequency interval of the channel includes:

determining the frequency hopping frequency interval based on a system bandwidth of the NB-IoT; or selecting a frequency from a frequency set as the frequency hopping frequency interval.

The apparatus in this embodiment may be configured to execute the technical solution on an NB-IoT base station side in method Embodiment 2. The implementation principle and technical effects are similar. Details are not described herein again.

### Embodiment 3 of a Channel Transmission Apparatus for NB-IoT

Optionally, based on Embodiment 1 or Embodiment 2 of the channel transmission apparatus for NB-IoT in this application, the time-frequency resource includes N physical resource block PRB groups, and each PRB group includes M consecutive PRBs, where M and N are integers greater than 0; and

the frequency hopping time interval includes an intra-group frequency hopping time interval and an inter-group frequency hopping time interval; and the frequency hopping frequency interval includes an intra-group frequency hopping frequency interval and an inter-group frequency hopping frequency interval, where

the intra-group frequency hopping time interval is less than the inter-group frequency hopping time interval, and a remainder of the inter-group frequency hopping time interval mod the intra-group frequency hopping time interval is non-zero; the intra-group frequency hopping frequency interval is L×W, and the inter-group frequency hopping frequency interval is O×M×W; and L and O are integers greater than 0, and W indicates a bandwidth occupied by one PRB.

Optionally, the time-frequency resource location determining module 402 is configured to:

determine, based on the initial frequency domain location, an intra-group frequency hopping frequency domain interval, and an inter-group frequency hopping frequency domain interval of the channel, a frequency domain location of the channel after the frequency hopping; and

determine, based on the intra-group frequency hopping time interval and the inter-group frequency hopping time interval of the channel, a time domain location of the channel after the frequency hopping.

Optionally, that the time-frequency resource location determining module 402 determines, based on the initial frequency domain location, an intra-group frequency hopping frequency domain interval, and an inter-group frequency hopping frequency domain interval of the channel, a frequency domain location of the channel after the frequency hopping includes:

for a frequency domain location Fᵢ of an i^{th} hop, determining a PRB group Zᵢ to which Fᵢ belongs by using the following formula (1):

Zᵢ=(Z₀+A)mod N (1); and

for the frequency domain location Fᵢ of the i^{th} hop, determining a location Pᵢ of Fᵢ in the PRB group by using the following formula (2):

Pᵢ=(P₀+B) mod M (2)

where i is an integer greater than 0, Z₀ indicates a PRB group to which an initial frequency domain location F₀ belongs, P₀ indicates a location of F₀ in the PRB group, A indicates the inter-group frequency hopping frequency domain interval, and B indicates the intra-group frequency hopping frequency domain interval.

Optionally, that the time-frequency resource location determining module 402 determines, based on the intra-group frequency hopping time interval and the inter-group frequency hopping time interval of the channel, a time domain location of the channel after the frequency hopping includes:

for a time domain location Tᵢ₊₁ of an (i+1)^{th} hop, when i+1 is an integer multiple of C mod D, determining Tᵢ₊₁ by using the following formula (3); otherwise, determining Tᵢ₊₁ by using the following formula (4):

Tᵢ₊₁=Tᵢ+(C mod D) (3)

Tᵢ₊₁+Tᵢ+D (4)

where i is an integer greater than 0, Tᵢ indicates a time domain location of an i^{th} hop, C indicates the inter-group frequency hopping time interval, and D indicates the intra-group frequency hopping time interval.

Optionally, a deployment manner of the NB-IoT includes: inband deployment, guard band deployment, or independent frequency band deployment.

The apparatus in this embodiment may be configured to execute the technical solution on an NB-IoT base station side in method Embodiment 3. The implementation principle and technical effects are similar. Details are not described herein again.

### Embodiment 4 of a Channel Transmission Apparatus for NB-IoT

Optionally, based on Embodiment 1 or Embodiment 2 of the channel transmission apparatus for NB-IoT in this application, a deployment manner of the NB-IoT is guard band deployment, a frequency domain location of an i^{th} hop of the channel is located within a guard band of one end of a Long Term Evolution LTE system transmission band, and a frequency domain location of an (i+1)^{th} hop of the channel is located within a guard band of the other end of the LTE system transmission band, where i is an integer greater than 0.

The apparatus in this embodiment may be configured to execute the technical solution on an NB-IoT base station side in method Embodiment 4. The implementation principle and technical effects are similar. Details are not described herein again.

### Embodiment 5 of a Channel Transmission Apparatus for NB-IoT

A structure of an apparatus in this embodiment is similar to a structure of the apparatus shown in FIG. 4, and may similarly include a frequency hopping information determining module, a time-frequency resource location determining module, and a transmission module. The frequency hopping information determining module is configured to determine frequency hopping information of a channel; the time-frequency resource location determining module is configured to determine, based on the frequency hopping information, a time-frequency resource location of the channel after frequency hopping; and the transmission module is configured to perform channel transmission with an NB-IoT base station on a time-frequency resource corresponding to the time-frequency resource location.

The apparatus in this embodiment may be configured to execute the technical solution on an NB-IoT terminal side in the method embodiment shown in FIG. 1. The implementation principle and technical effects are similar. Details are not described herein again.

### Embodiment 6 of a Channel Transmission Apparatus for NB-IoT

Optionally, based on Embodiment 5 of the channel transmission apparatus for NB-IoT in this application, the frequency hopping information determining module is configured to:

determine an initial frequency domain location, a frequency hopping frequency interval, and a frequency hopping time interval of the channel.

Optionally, that the frequency hopping information determining module determines an initial frequency domain location of the channel includes:

determining the initial frequency domain location of the channel based on a cell identifier ID of a cell in which the channel is located; or determining the initial frequency domain location based on first notification signaling sent by the NB-IoT base station, where the first notification signaling is used for indicating the initial frequency domain location.

Optionally, that the frequency hopping information determining module determines a frequency hopping time interval of the channel includes:

determining the frequency hopping time interval based on a type of the channel; or determining the frequency hopping time interval based on a coverage level of the NB-IoT terminal; or determining the frequency hopping time interval based on second notification signaling sent by the NB-IoT base station, where the second notification signaling is used for indicating the frequency hopping time interval.

Optionally, that the frequency hopping information determining module determines a frequency hopping frequency interval of the channel includes:

determining the frequency hopping frequency interval based on a system bandwidth of the NB-IoT; or determining the frequency hopping frequency interval based on third notification signaling sent by the NB-IoT base station, where the third notification signaling is used for indicating the frequency hopping frequency interval.

The apparatus in this embodiment may be configured to execute the technical solution on an NB-IoT terminal side in method Embodiment 2. The implementation principle and technical effects are similar. Details are not described herein again.

### Embodiment 7 of a Channel Transmission Apparatus for NB-IoT

Optionally, based on Embodiment 5 or Embodiment 6 of the channel transmission apparatus for NB-IoT in this application, the time-frequency resource includes N physical resource block PRB groups, and each PRB group includes M consecutive PRBs, where M and N are integers greater than 0; and

the frequency hopping time interval includes an intra-group frequency hopping time interval and an inter-group frequency hopping time interval; and the frequency hopping frequency interval includes an intra-group frequency hopping frequency interval and an inter-group frequency hopping frequency interval, where

the intra-group frequency hopping time interval is less than the inter-group frequency hopping time interval, and a remainder of the inter-group frequency hopping time interval mod the intra-group frequency hopping time interval is non-zero; the intra-group frequency hopping frequency interval is L×W, and the inter-group frequency hopping frequency interval is O×M×W; and L and O are integers greater than 0, and W indicates a bandwidth occupied by one PRB.

Optionally, the time-frequency resource location determining module is configured to:

determine, based on the initial frequency domain location, an intra-group frequency hopping frequency domain interval, and an inter-group frequency hopping frequency domain interval of the channel, a frequency domain location of the channel after the frequency hopping; and

determine, based on the intra-group frequency hopping time interval and the inter-group frequency hopping time interval of the channel, a time domain location of the channel after the frequency hopping.

Optionally, that the time-frequency resource location determining module determines, based on the initial frequency domain location, an intra-group frequency hopping frequency domain interval, and an inter-group frequency hopping frequency domain interval of the channel, a frequency domain location of the channel after the frequency hopping includes:

for a frequency domain location Fᵢ of an i^{th} hop, determining a PRB group Zᵢ to which Fᵢ belongs by using the following formula (1):

Zᵢ=(Z₀+A)mod N (1); and

for the frequency domain location Fᵢ of the i^{th} hop, determining a location of Fᵢ in the PRB group by using the following formula (2):

Pᵢ=(P₀+B) mod M (2)

where i is an integer greater than 0, Z₀ indicates a PRB group to which an initial frequency domain location F₀ belongs, P₀ indicates a location of F₀ in the PRB group, A indicates the inter-group frequency hopping frequency domain interval, and B indicates the intra-group frequency hopping frequency domain interval.

Optionally, that the time-frequency resource location determining module determines, based on the intra-group frequency hopping time interval and the inter-group frequency hopping time interval of the channel, a time domain location of the channel after the frequency hopping includes:

for a time domain location Tᵢ₊₁ of an (i+1)^{th} hop, when i+1 is an integer multiple of C mod D, determining Tᵢ₊₁ by using the following formula (3); otherwise, determining Tᵢ₊₁ by using the following formula (4):

Tᵢ₊₁=Tᵢ+(C mod D) (3)

Tᵢ₊₁=Tᵢ+D (4)

where i is an integer greater than 0, Tᵢ indicates a time domain location of an i^{th} hop, C indicates the inter-group frequency hopping time interval, and D indicates the intra-group frequency hopping time interval.

Optionally, a deployment manner of the NB-IoT includes: inband deployment, guard band deployment, or independent frequency band deployment.

The apparatus in this embodiment may be configured to execute the technical solution on an NB-IoT terminal side in method Embodiment 3. The implementation principle and technical effects are similar. Details are not described herein again.

### Embodiment 8 of a Channel Transmission Apparatus for NB-IoT

Optionally, based on Embodiment 5 or Embodiment 6 of the channel transmission apparatus for NB-IoT in this application, a deployment manner of the NB-IoT is guard band deployment, a frequency domain location of an i^{th} hop of the channel is located within a guard band of one end of a Long Term Evolution LTE system transmission band, and a frequency domain location of an (i+1)^{th} hop of the channel is located within a guard band of the other end of the LTE system transmission band, where i is an integer greater than 0.

The apparatus in this embodiment may be configured to execute the technical solution on an NB-IoT terminal side in method Embodiment 4. The implementation principle and technical effects are similar. Details are not described herein again.

This application further provides a channel transmission system for NB-IoT, including: the apparatus in any embodiment of Embodiment 1 to Embodiment 4 of the channel transmission apparatus for NB-IoT, and the apparatus in any embodiment of Embodiment 5 to Embodiment 8 of the channel transmission apparatus for NB-IoT.

FIG. 5 is a schematic structural diagram of Embodiment 1 of an NB-IoT base station according to this application. As shown in FIG. 5, the NB-IoT base station in this embodiment may include: a processor 501 and a transceiver 502. The processor 501 is configured to determine frequency hopping information of a channel. The processor 501 is further configured to determine, based on the frequency hopping information, a time-frequency resource location of the channel after frequency hopping. The transceiver 502 is configured to perform channel transmission with an NB-IoT terminal on a time-frequency resource corresponding to the time-frequency resource location.

It should be noted that, the transceiver 502 may be a component, for example, an antenna that has both receiving and sending functions; or may be two components, for example, one antenna that has a receiving function and one antenna that has a sending function.

The NB-IoT base station in this embodiment may be configured to execute the technical solution on an NB-IoT base station side in the method embodiment shown in FIG. 1. The implementation principle and technical effects are similar. Details are not described herein again.

### Embodiment 2 of an NB-IoT Base Station

Optionally, based on Embodiment 1 of the NB-IoT base station in this application, that the processor 501 determines frequency hopping information of a channel includes: determining an initial frequency domain location, a frequency hopping frequency interval, and a frequency hopping time interval of the channel.

Optionally, that the processor 501 determines an initial frequency domain location of the channel includes:

determining the initial frequency domain location of the channel based on a cell identifier ID of a cell in which the channel is located; or randomly selecting the initial frequency domain location of the channel from all unallocated frequency domain locations.

Optionally, that the processor 501 determines a frequency hopping time interval of the channel includes:

determining the frequency hopping time interval based on a type of the channel; or determining the frequency hopping time interval based on a coverage level of the NB-IoT terminal; or selecting an interval from an interval set as the frequency hopping time interval.

Optionally, that the processor 501 determines a frequency hopping frequency interval of the channel includes:

determining the frequency hopping frequency interval based on a system bandwidth of the NB-IoT; or selecting a frequency from a frequency set as the frequency hopping frequency interval.

The NB-IoT base station in this embodiment may be configured to execute the technical solution on an NB-IoT base station side in method Embodiment 2. The implementation principle and technical effects are similar. Details are not described herein again.

### Embodiment 3 of an NB-IoT Base Station

Optionally, based on Embodiment 1 or Embodiment 2 of the NB-IoT base station in this application, the time-frequency resource includes N physical resource block PRB groups, and each PRB group includes M consecutive PRBs, where M and N are integers greater than 0; and

the frequency hopping time interval includes an intra-group frequency hopping time interval and an inter-group frequency hopping time interval; and the frequency hopping frequency interval includes an intra-group frequency hopping frequency interval and an inter-group frequency hopping frequency interval, where

the intra-group frequency hopping time interval is less than the inter-group frequency hopping time interval, and a remainder of the inter-group frequency hopping time interval mod the intra-group frequency hopping time interval is non-zero; the intra-group frequency hopping frequency interval is L×W, and the inter-group frequency hopping frequency interval is O×M×W; and L and O are integers greater than 0, and W indicates a bandwidth occupied by one PRB.

Optionally, that the processor 501 determines, based on the frequency hopping information, a time-frequency resource location of the channel after frequency hopping includes:

determining, based on the initial frequency domain location, an intra-group frequency hopping frequency domain interval, and an inter-group frequency hopping frequency domain interval of the channel, a frequency domain location of the channel after the frequency hopping; and

determining, based on the intra-group frequency hopping time interval and the inter-group frequency hopping time interval of the channel, a time domain location of the channel after the frequency hopping.

Optionally, that the processor 501 determines, based on the initial frequency domain location, an intra-group frequency hopping frequency domain interval, and an inter-group frequency hopping frequency domain interval of the channel, a frequency domain location of the channel after the frequency hopping includes:

for a frequency domain location Fᵢ of an i^{th} hop, determining a PRB group Zᵢ to which Fᵢ belongs by using the following formula (1):

Zᵢ=(Z₀+A)mod N (1); and

for the frequency domain location Fᵢ of the i^{th} hop, determining a location Pᵢ of Fᵢ in the PRB group by using the following formula (2):

Pᵢ=(P₀+B) mod M (2)

where i is an integer greater than 0, Z₀ indicates a PRB group to which an initial frequency domain location F₀ belongs, P₀ indicates a location of F₀ in the PRB group, A indicates the inter-group frequency hopping frequency domain interval, and B indicates the intra-group frequency hopping frequency domain interval.

Optionally, that the processor 501 determines, based on the intra-group frequency hopping time interval and the inter-group frequency hopping time interval of the channel, a time domain location of the channel after the frequency hopping includes:

for a time domain location Tᵢ₊₁ of an (i+1)^{th} hop, when i+1 is an integer multiple of C mod D, determining Tᵢ₊₁ by using the following formula (3); otherwise, determining Tᵢ₊₁ by using the following formula (4):

Tᵢ₊₁=Tᵢ+(C mod D) (3)

Tᵢ₊₁=Tᵢ+D (4)

where i is an integer greater than 0, Tᵢ indicates a time domain location of an i^{th} hop, C indicates the inter-group frequency hopping time interval, and D indicates the intra-group frequency hopping time interval.

Optionally, a deployment manner of the NB-IoT includes: inband deployment, guard band deployment, or independent frequency band deployment.

The NB-IoT base station in this embodiment may be configured to execute the technical solution on an NB-IoT base station side in method Embodiment 3. The implementation principle and technical effects are similar. Details are not described herein again.

### Embodiment 4 of an NB-IoT Base Station

Optionally, based on Embodiment 1 or Embodiment 2 of the NB-IoT base station in this application, a deployment manner of the NB-IoT is guard band deployment, a frequency domain location of an i^{th} hop of the channel is located within a guard band of one end of a Long Term Evolution LTE system transmission band, and a frequency domain location of an (i+1)^{th} hop of the channel is located within a guard band of the other end of the LTE system transmission band, where i is an integer greater than 0.

The NB-IoT base station in this embodiment may be configured to execute the technical solution on an NB-IoT base station side in method Embodiment 4. The implementation principle and technical effects are similar. Details are not described herein again.

### Embodiment 1 of an NB-IoT Terminal

A structure of an NB-IoT terminal in this embodiment is similar to a structure of the NB-IoT base station shown in FIG. 5, and may similarly include a processor and a transceiver. The processor is configured to determine frequency hopping information of a channel. The processor is further configured to determine, based on the frequency hopping information, a time-frequency resource location of the channel after frequency hopping. The transceiver is configured to perform channel transmission with an NB-IoT base station on a time-frequency resource corresponding to the time-frequency resource location.

The NB-IoT terminal in this embodiment may be configured to execute the technical solution on an NB-IoT terminal side in the method embodiment shown in FIG. 1. The implementation principle and technical effects are similar. Details are not described herein again.

### Embodiment 2 of an NB-IoT Terminal

Optionally, based on Embodiment 1 of the NB-IoT terminal in this application, that the processor determines frequency hopping information of a channel includes:

determining an initial frequency domain location, a frequency hopping frequency interval, and a frequency hopping time interval of the channel.

Optionally, that the processor determines an initial frequency domain location of the channel includes:

determining the initial frequency domain location of the channel based on a cell identifier ID of a cell in which the channel is located; or determining the initial frequency domain location based on first notification signaling sent by the NB-IoT base station, where the first notification signaling is used for indicating the initial frequency domain location.

Optionally, that the processor determines a frequency hopping time interval of the channel includes:

determining the frequency hopping time interval based on a type of the channel; or determining the frequency hopping time interval based on a coverage level of the NB-IoT terminal; or determining the frequency hopping time interval based on second notification signaling sent by the NB-IoT base station, where the second notification signaling is used for indicating the frequency hopping time interval.

Optionally, that the processor determines a frequency hopping frequency interval of the channel includes:

determining the frequency hopping frequency interval based on a system bandwidth of the NB-IoT; or determining the frequency hopping frequency interval based on third notification signaling sent by the NB-IoT base station, where the third notification signaling is used for indicating the frequency hopping frequency interval.

The NB-IoT terminal in this embodiment may be configured to execute the technical solution on an NB-IoT terminal side in method Embodiment 2. The implementation principle and technical effects are similar. Details are not described herein again.

### Embodiment 3 of an NB-IoT Terminal

Optionally, based on Embodiment 1 or Embodiment 2 of the NB-IoT terminal in this application, the time-frequency resource includes N physical resource block PRB groups, and each PRB group includes M consecutive PRBs, where M and N are integers greater than 0; and

the frequency hopping time interval includes an intra-group frequency hopping time interval and an inter-group frequency hopping time interval; and the frequency hopping frequency interval includes an intra-group frequency hopping frequency interval and an inter-group frequency hopping frequency interval, where

the intra-group frequency hopping time interval is less than the inter-group frequency hopping time interval, and a remainder of the inter-group frequency hopping time interval mod the intra-group frequency hopping time interval is non-zero; the intra-group frequency hopping frequency interval is L×W, and the inter-group frequency hopping frequency interval is O×M×W; and L and O are integers greater than 0, and W indicates a bandwidth occupied by one PRB.

Optionally, that the processor determines, based on the frequency hopping information, a time-frequency resource location of the channel after frequency hopping includes:

determining, based on the initial frequency domain location, an intra-group frequency hopping frequency domain interval, and an inter-group frequency hopping frequency domain interval of the channel, a frequency domain location of the channel after the frequency hopping; and

determining, based on the intra-group frequency hopping time interval and the inter-group frequency hopping time interval of the channel, a time domain location of the channel after the frequency hopping.

Optionally, that the processor determines, based on the initial frequency domain location, an intra-group frequency hopping frequency domain interval, and an inter-group frequency hopping frequency domain interval of the channel, a frequency domain location of the channel after the frequency hopping includes:

for a frequency domain location Fᵢ of an i^{th} hop, determining a PRB group Zᵢ to which Fᵢ belongs by using the following formula (1):

Zᵢ=(Z₀+A)mod N (1); and

for the frequency domain location Fᵢ of the i^{th} hop, determining a location Pᵢ of Fᵢ in the PRB group by using the following formula (2):

Pᵢ=(P₀+B) mod M (2)

where i is an integer greater than 0, Z₀ indicates a PRB group to which an initial frequency domain location F₀ belongs, P₀ indicates a location of F₀ in the PRB group, A indicates the inter-group frequency hopping frequency domain interval, and B indicates the intra-group frequency hopping frequency domain interval.

Optionally, that the processor determines, based on the intra-group frequency hopping time interval and the inter-group frequency hopping time interval of the channel, a time domain location of the channel after the frequency hopping includes:

for a time domain location Tᵢ₊₁ of an (i+1)^{th} hop, when i+1 is an integer multiple of C mod D, determining Tᵢ₊₁ by using the following formula (3); otherwise, determining Tᵢ₊₁ by using the following formula (4):

Tᵢ₊₁=Tᵢ+(C mod D) (3)

Tᵢ₊₁=Tᵢ+D (4)

where i is an integer greater than 0, Tᵢ indicates a time domain location of an i^{th} hop, C indicates the inter-group frequency hopping time interval, and D indicates the intra-group frequency hopping time interval.

Optionally, a deployment manner of the NB-IoT includes: inband deployment, guard band deployment, or independent frequency band deployment.

The NB-IoT terminal in this embodiment may be configured to execute the technical solution on an NB-IoT terminal side in method Embodiment 3. The implementation principle and technical effects are similar. Details are not described herein again.

### Embodiment 4 of an NB-IoT Terminal

Optionally, based on Embodiment 1 or Embodiment 2 of the NB-IoT terminal in this application, a deployment manner of the NB-IoT is guard band deployment, a frequency domain location of an i^{th} hop of the channel is located within a guard band of one end of a Long Term Evolution LTE system transmission band, and a frequency domain location of an (i+1)^{th} hop of the channel is located within a guard band of the other end of the LTE system transmission band, where i is an integer greater than 0.

The NB-IoT terminal in this embodiment may be configured to execute the technical solution on an NB-IoT terminal side in method Embodiment 4. The implementation principle and technical effects are similar. Details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

What is claimed is:

1. A channel transmission method for Narrowband Internet of Things (NB-IoT), the method comprising:
determining, by an NB-IoT terminal, frequency hopping information of a channel;
determining, by the NB-IoT terminal based on the frequency hopping information, a time-frequency resource location of the channel after frequency hopping; and
performing, by the NB-IoT terminal, channel transmission with an NB-IoT base station on a time-frequency resource corresponding to the time-frequency resource location.

2. The method according to claim 1, wherein determining, by an NB-IoT terminal, frequency hopping information of a channel comprises:
determining, by the NB-IoT terminal, an initial frequency domain location, a frequency hopping frequency interval, and a frequency hopping time interval of the channel.

3. The method according to claim 2, wherein determining, by the NB-IoT terminal, an initial frequency domain location of the channel comprises:
determining, by the NB-IoT terminal, the initial frequency domain location of the channel based on a cell identifier (ID) of a cell in which the channel is located; or
determining, by the NB-IoT terminal, the initial frequency domain location based on first notification signaling sent by the NB-IoT base station, wherein the first notification signaling is used for indicating the initial frequency domain location.

4. The method according to claim 2, wherein determining, by the NB-IoT terminal, a frequency hopping time interval of the channel comprises:
determining, by the NB-IoT terminal, the frequency hopping time interval based on a type of the channel; or
determining, by the NB-IoT terminal, the frequency hopping time interval based on a coverage level of the NB-IoT terminal; or
determining, by the NB-IoT terminal, the frequency hopping time interval based on second notification signaling sent by the NB-IoT base station, wherein the second notification signaling is used for indicating the frequency hopping time interval.

5. The method according to claim 2, wherein determining, by the NB-IoT terminal, a frequency hopping frequency interval of the channel comprises:
determining, by the NB-IoT terminal, the frequency hopping frequency interval based on a system bandwidth of the NB-IoT; or
determining, by the NB-IoT terminal, the frequency hopping frequency interval based on third notification signaling sent by the NB-IoT base station, wherein the third notification signaling is used for indicating the frequency hopping frequency interval.

6. The method according to claim 2, wherein:
the time-frequency resource comprises N physical resource block (PRB) groups, and each PRB group comprises M consecutive PRBs, wherein M and N are integers greater than 0;
the frequency hopping time interval comprises an intra-group frequency hopping time interval and an inter-group frequency hopping time interval;
the frequency hopping frequency interval comprises an intra-group frequency hopping frequency interval and an inter-group frequency hopping frequency interval; and
wherein the intra-group frequency hopping time interval is less than the inter-group frequency hopping time interval, a remainder of the inter-group frequency hopping time interval mod the intra-group frequency hopping time interval is non-zero, the intra-group frequency hopping frequency interval is L×W, the inter-group frequency hopping frequency interval is O×M×W, and L and O are integers greater than 0, and W indicates a bandwidth occupied by one PRB.

7. The method according to claim 6, further comprising:
determining, by the NB-IoT terminal based on the initial frequency domain location, the intra-group frequency hopping frequency interval, and the inter-group frequency hopping frequency interval, a frequency domain location of the channel after the frequency hopping; and
determining, by the NB-IoT terminal based on the intra-group frequency hopping time interval and the inter-group frequency hopping time interval, a time domain location of the channel after the frequency hopping.

8. The method according to claim 7, wherein determining, by the NB-IoT terminal based on the initial frequency domain location, the intra-group frequency hopping frequency interval, and the inter-group frequency hopping frequency interval of the channel, a frequency domain location of the channel after the frequency hopping comprises:
for a frequency domain location Fᵢ of an i^{th} hop, determining a PRB group Zᵢ to which Fᵢ belongs by using the following formula (1):
Zᵢ=(Z₀+A)mod N (1); and
for the frequency domain location Fᵢ of the i^{th} hop, determining a location Pᵢ of Fᵢ in the PRB group by using the following formula (2):
Pᵢ=(P₀+B) mod M (2)
wherein i is an integer greater than 0, Z₀ indicates a PRB group to which an initial frequency domain location F₀ belongs, P₀ indicates a location of F₀ in the PRB group, A indicates the inter-group frequency hopping frequency interval, and B indicates the intra-group frequency hopping frequency interval.

9. A computer program product, stored in a non-transitory medium, comprising instructions which, when executed by a computer, cause the computer to:
determine frequency hopping information of a channel;
determine, based on the frequency hopping information, a time-frequency resource location of the channel after frequency hopping; and
perform channel transmission with an Narrowband Internet of Things (NB-IoT) base station on a time-frequency resource corresponding to the time-frequency resource location.

10. A channel transmission apparatus for Narrowband Internet of Things (NB-IoT), the apparatus comprising:
a processor configure to:
determine frequency hopping information of a channel, and
determine, based on the frequency hopping information, a time-frequency resource location of the channel after frequency hopping; and
a transceiver configured to perform channel transmission with an NB-IoT base station on a time-frequency resource corresponding to the time-frequency resource location.

11. The apparatus according to claim 10, wherein the processor is configured to:
determine an initial frequency domain location, a frequency hopping frequency interval, and a frequency hopping time interval of the channel.

12. The apparatus according to claim 11, wherein to determine an initial frequency domain location of the channel, the processor is configured to:
determine the initial frequency domain location of the channel based on a cell identifier (ID) of a cell in which the channel is located; or
determine the initial frequency domain location based on first notification signaling sent by the NB-IoT base station, wherein the first notification signaling is used for indicating the initial frequency domain location.

13. The apparatus according to claim 11, wherein to determine a frequency hopping time interval of the channel, the processor is configured to:
determine the frequency hopping time interval based on a type of the channel; or
determine the frequency hopping time interval based on a coverage level at which an NB-IoT terminal is located; or
determine the frequency hopping time interval based on second notification signaling sent by the NB-IoT base station, wherein the second notification signaling is used for indicating the frequency hopping time interval.

14. The apparatus according to claim 11, wherein to determine a frequency hopping frequency interval of the channel, the processor is configured to:
determine the frequency hopping frequency interval based on a system bandwidth of the NB-IoT; or
determine the frequency hopping frequency interval based on third notification signaling sent by the NB-IoT base station, wherein the third notification signaling is used for indicating the frequency hopping frequency interval.

15. The apparatus according to claim 11, wherein:
the time-frequency resource comprises N physical resource block (PRB) groups, and each PRB group comprises M consecutive PRBs, wherein M and N are integers greater than 0;
the frequency hopping time interval comprises an intra-group frequency hopping time interval and an inter-group frequency hopping time interval;
the frequency hopping frequency interval comprises an intra-group frequency hopping frequency interval and an inter-group frequency hopping frequency interval; and
wherein the intra-group frequency hopping time interval is less than the inter-group frequency hopping time interval, and a remainder of the inter-group frequency hopping time interval mod the intra-group frequency hopping time interval is non-zero, the intra-group frequency hopping frequency interval is L×W, the inter-group frequency hopping frequency interval is O×M×W, L and O are integers greater than 0, and W indicates a bandwidth occupied by one PRB.

16. The apparatus according to claim 15, wherein the processor is configured to:
determine, based on the initial frequency domain location, the intra-group frequency hopping frequency interval, and the inter-group frequency hopping frequency interval, a frequency domain location of the channel after the frequency hopping; and
determine, based on the intra-group frequency hopping time interval and the inter-group frequency hopping time interval, a time domain location of the channel after the frequency hopping.

17. The apparatus according to claim 16, wherein to determine, based on the initial frequency domain location, the intra-group frequency hopping frequency interval, and the inter-group frequency hopping frequency interval of the channel, a frequency domain location of the channel after the frequency hopping, the processor is configured to:
for a frequency domain location Fᵢ of an i^{th} hop, determine a PRB group Zᵢ to which Fᵢ belongs by using the following formula (1):
Zᵢ=(Z₀+A)mod N (1); and
for the frequency domain location Fᵢ of the i^{th} hop, determine a location Pᵢ of Fᵢ in the PRB group by using the following formula (2):
Pᵢ=(P₀+B) mod M (2)
wherein i is an integer greater than 0, Z₀ indicates a PRB group to which an initial frequency domain location F₀ belongs, P₀ indicates a location of F₀ in the PRB group, A indicates the inter-group frequency hopping frequency interval, and B indicates the intra-group frequency hopping frequency interval.

18. The apparatus according to claim 16, wherein to determine, based on the intra-group frequency hopping time interval and the inter-group frequency hopping time interval of the channel, a time domain location of the channel after the frequency hopping, the processor is configured to:
for a time domain location Tᵢ₊₁ of an (i+1)^{th} hop, when i+1 is an integer multiple of C mod D, determine Tᵢ₊₁ by using the following formula (3); otherwise, determine Tᵢ₊₁ by using the following formula (4):
Tᵢ₊₁=Tᵢ+(C mod D) (3)
Tᵢ₊₁=Tᵢ+D (4)
wherein i is an integer greater than 0, Tᵢ indicates a time domain location of an i^{th} hop, C indicates the inter-group frequency hopping time interval, and D indicates the intra-group frequency hopping time interval.

19. The apparatus according to claim 10, wherein a deployment manner of the NB-IoT comprises:
inband deployment, guard band deployment, or independent frequency band deployment.

20. The apparatus according to claim 10, wherein:
a deployment manner of the NB-IoT is guard band deployment;
a frequency domain location of an i^{th} hop of the channel is located within a guard band of one end of a Long Term Evolution (LTE) system transmission band; and
a frequency domain location of an (i+1)^{th} hop of the channel is located within a guard band of the other end of the LTE system transmission band, wherein i is an integer greater than 0.
